(19) United States
(12) Patent Application Publication
(10) Pub. No.: US 2006/0277333 A1
(43) Pub. Date: Dec. 7, 2006

(54) Portable data storage device

(75) Inventors: Wong Hoo Sim, Singapore (SG); Chian Yi Loo, Singapore (SG); Chin Fang Lim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd.

(21) Appl. No.: 11/142,691

(22) Filed: Jun. 1, 2005

(51) Int. Cl. G06F 13/38

(52) U.S. Cl. 710/62

(57) ABSTRACT

A portable data storage device (100) for connection with an electronic device (51), the device (100) comprising: a first data connector (110) for connecting to a host port (50) of the electronic device (51), a second data connector (120) for connecting to a second portable data storage device (200), wherein the first and second data connectors (110, 120) comply with a common connector standard.

### TECHNICAL FIELD

The invention concerns a portable data storage device for connection with an electronic device.

### BACKGROUND OF THE INVENTION

Certain electronic devices such as desktop computers, notebook computers, personal digital assistants (PDA) and smart phones have a limited number of peripheral ports due to the physical constraints of the computing device. The Universal Serial Bus (USB) interface is widely embraced by computer manufacturers and is thus a generally accepted standard to enable interoperability and interface between computing devices (USB host) and peripheral devices (USB clients). It is not uncommon to use multiple peripheral devices at the same time, for example, a keyboard, mouse, speakers, thumbdrive/keydrive, MP3 player or PDA. Thus these days, one frequently finds themselves with all the USB ports used and must inconveniently detach one peripheral device in order to attach another to the same USB port.

A USB hub is one solution proposed. A USB hub connects several USB client devices to a USB host. A USB hub typically consists of a single upstream port to connect directly to computer or another hub and multiple downstream ports for connection with USB devices. However, a USB hub is an additional cost which only serves a single purpose and is therefore not an attractive purchase for most consumers. Furthermore, once all the ports of the USB hub are used, the same problem is experienced.

### SUMMARY OF THE INVENTION

In a first preferred aspect, there is provided a portable data storage device for connection with an electronic device, the device comprising:
a first data connector for connecting to a host port of the electronic device,
a second data connector for connecting to a second portable data storage device,
wherein the first and second data connectors comply with a common connector standard.

The common connector standard may be Universal Serial Bus (USB) or IEEE 1394.

The first data connector may be a USB Type A male connector and the second data connector is a USB Type A female connector.

A cascade module may be provided to copy a file allocation table of the second portable data storage device to a memory of the first portable data storage device when the second portable data storage device is operatively connected to the first portable data storage device. The memory may be volatile or non-volatile.

The cascade module may rearrange the file allocation table of the second portable data storage device.

The cascade module may present the first and second portable data storage devices as a single hardware device to the electronic device.

The cascade module may present the first and second portable data storage devices in separate drives when the first and second portable data storage devices are operatively connected to the electronic device.

The cascade module may present the first and second portable data storage devices in a single drive, and the second portable data storage device is presented in a directory of the drive.

The file allocation tables of the first and second portable data storage devices may be read when a read/write operation request to the first or second portable data storage devices is received, wherein the file allocation table of the second portable data storage device is read from the memory of the first portable data storage device.

The file allocation tables of the first and second portable data storage devices may each be stored in non-volatile memory of the first and second portable data storage devices, respectively.

An audio decoder may be provided to process and replay audio files selected from the group consisting of MP3, WAV and WMA files.

A video decoder may be provided to process and replay video files selected from the group consisting of MPEG, AVI and ASF files.

The second data connector may enable connection to a device without a file allocation table, the device being selected from the group consisting of printers, scanners, keyboards, mice, joysticks, flight yokes, digital cameras, webcams, scientific data acquisition devices, modems, or speakers.

A third data connector may be provided for connecting with a third portable data storage device or non-storage device and create a hub, wherein the first, second and third data connectors comply with a common connector standard.

In a second aspect, there is provided a method for cascading at least two portable data storage devices to connect with an electronic device, the method comprising:
operatively connecting a first portable data storage device to a host port of the electronic device;
operatively connecting a second portable data storage device to the first portable data storage device;
wherein a file allocation table of the second portable data storage device is copied to a memory of the first portable data storage device when the second portable data storage device is operatively connected to the first portable data storage device.

The method may further comprise operatively connecting additional portable data storage devices, wherein the file allocation table of each additional portable data storage device is ultimately copied to the memory of the first portable data storage device.

In a third aspect, there is provided a portable data storage device for connection with an electronic device, the device comprising:
a first data connector for connecting to a host port of the electronic device;
memory for receiving and storing data from the electronic device via the host port; and
a second data connector for connecting to a second portable data storage device thereby to facilitate communication between the electronic device and the second portable data storage device via the first data connector;
wherein the first and second data connectors comply with a common connector standard.

### BRIEF DESCRIPTION OF THE DRAWINGS

An example of the invention will now be described with reference to the accompanying drawings, in which:

FIG. 1 is a block diagram of a device in accordance with the present invention, prior to use;

FIG. 2 is a block diagram of the operation of the device in accordance with the present invention, in use; and

FIG. 3 is a perspective view of the device in accordance with the present invention.

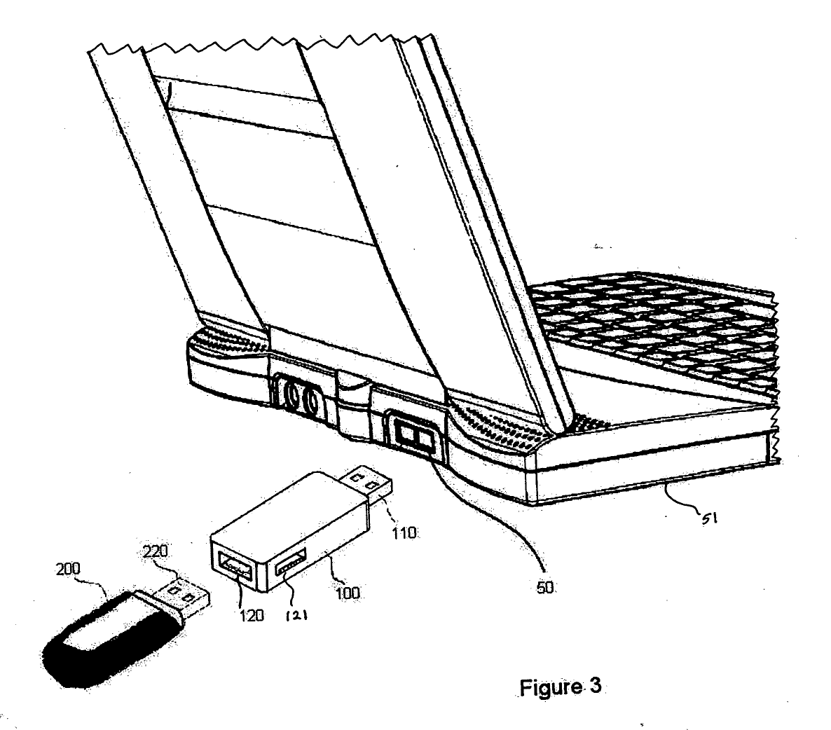

### DETAILED DESCRIPTION OF THE DRAWINGS

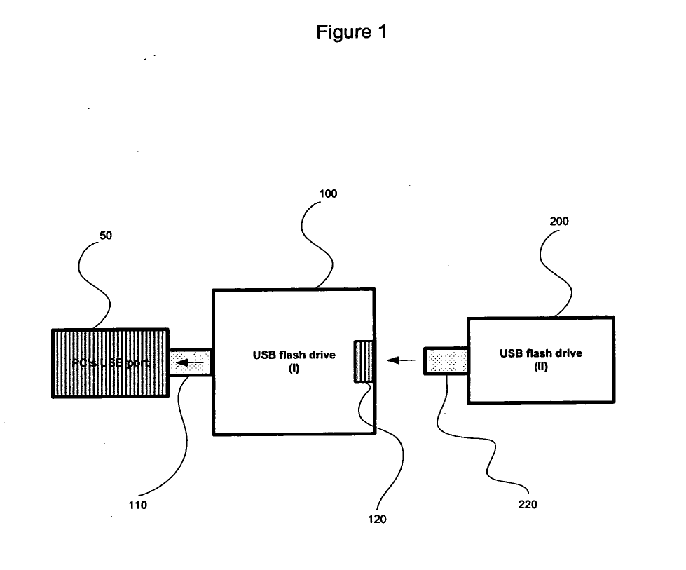

FIG. 1 and the following discussion are intended to provide a brief, general description of a suitable computing environment in which the present invention may be implemented. Although not required, the invention will be described in the general context of computer-executable instructions, such as program modules, being executed by a personal computer. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring to FIG. 1, a portable data storage device 100 is provided for connection with a notebook computer 51. The first device 100 includes flash memory to store information and data in a non-volatile state and complies with the Universal Serial Bus (USB) standard. In one embodiment, the storage capacity of the first device 100 may be several GB. The first device 100 comprises a USB Type A male connector 110 at one side and a USB Type A female connector 120 at the opposite side of the first device 100. In use, the USB Type A male connector 110 connects to a host port 50 of the notebook computer 51 and the USB Type A female connector 120 connects to a second portable data storage device 200. The second device 200 comprises a USB Type A male connector 220 to connect with the USB Type A female connector 120 of the first device 100. In one embodiment, the storage capacity of the second device 200 may be several GB.

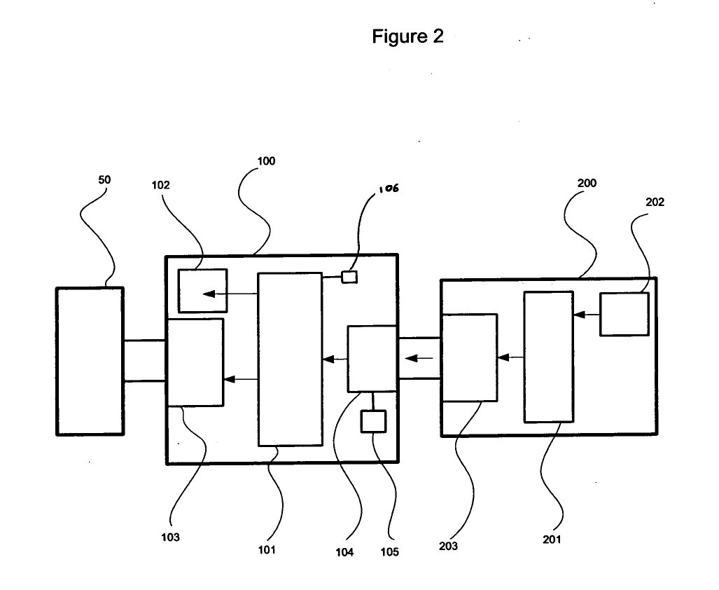

Referring to FIG. 2, the first device 100 comprises a processor 101, memory 102, USB device port (UDP) 103, USB host port (UHP) 104 and USB host controller 105. A mass storage class driver is stored in firmware to allow the first device 100 to interface with the second device 200. Typically, firmware resides in a memory of the processor 101. A file allocation table (FAT 1) is stored on the first device 100 to provide a map of where files are physically stored on the flash memory of the first device 100. FAT 1 is stored in the flash memory. A temporary copy of FAT 1 may be stored in the memory 102.

The second device 200 also comprises a processor 201, memory 202, and USB device port (UDP) 203. The second device 200 includes flash memory to store information and data in a non-volatile state and complies with the Universal Serial Bus (USB) standard. The memory 202 stores a file allocation table (FAT 2) which provides a map of where files are physically stored on the flash memory of the second device 200. The USB host controller 105 and UHP 104 of the first device 100 enable communication with second device 200 via UDP 203.

The second device 200 is operatively connected to the first device 100 by inserting USB Type A male connector 220 into USB Type A female connector 120. When the connection is detected, a cascade module 106 in the firmware of the first device 100 reads the memory 202, makes a copy of FAT 2 and stores it to the memory 102. In one embodiment, the cascade module 106 rearranges FAT 2 in memory 102 for optimization and to shorten access/seek times.

The first device 100 is operatively connected to the notebook 51 by inserting the USB Type A male connector 120 into a USB Type A female connector 50. When the connection is detected by the operating system of the notebook 51, it interfaces with the first device 100 via its mass storage class driver. When the operating system performs a read/write operation on the devices 100, 200, it reads/writes to the FATs of the devices 100, 200. The cascade module 106 manages the read/write operations to the second device 200. During a read operation for a file stored on the second device 200, the copy of FAT 2 stored in the memory 102 of first device 100 is read by the operating system. During a write operation to the second device 200, the FAT 2 is updated and a corresponding update to the copy of FAT 2 is also made or the updated FAT 2 is copied again to the first device 100 when the write operation is completed.

The cascade module 106 presents the first device 100 and the second device 200 as a single hardware storage device to the notebook 51. In one embodiment, the files stored on both devices 100, 200 are presented in separate drives in a similar manner as though the hardware storage device was partitioned or as separate hardware storage devices installed. In another embodiment, the files of the first device 100 are presented in a single drive, and the files of the second device 200 are presented in a directory of that drive.

In another embodiment, the first device 100 is modified to incorporate an audio decoder or video decoder to enable processing and replay of audio or video files stored on the first device without requiring any processing by the notebook 51. The modified first device 100 may include a digital signal processor (DSP) chip, audio and video codecs and an amplifier. The modified first device 100 may include output jacks for audio and video output and be operatively connectable with a power source such as battery holder assembly to enable portable playback of the audio and video files. For example, the modified first device 100 may be operatively connected with the battery holder assembly of the Creative Muvo™ MP3 player.

Other devices without a file allocation table may also connect to the first device 100 via USB Type A female connector 120. The other devices include printers, scanners, keyboards, mice, joysticks, flight yokes, digital cameras, webcams, scientific data acquisition devices, modems, speakers, telephones, or video phones.

Another USB Type A female connector 121 may be included with the first device 100 for connecting to a third portable data storage device or other devices without a file allocation table. This creates a hub in which all connecting devices comply with the Universal Serial Bus (USB) standard.

The first device 100 may have a LED to visually indicate when a read/write operation is being performed by the first device 100.

Although a second device 200 has been described, it is possible that the second device 200 may be a first device 100 in accordance with the present invention. In such a scenario, a cascading effect is created where a series of first devices 100 are connected to each other and copies of all the FATs of the devices 100 are ultimately stored in the memory 102 of the first device 100 which is operatively connected to the notebook 51. As each first device 100 is connected to a previous one, its FAT is copied to the previous one and so forth until a copy of the FAT reaches the first device 100 operatively connected to the notebook 51. Alternatively, each FAT is directly copied to the first device 100 operatively connected to the notebook 51. The cascade module 106 presents all the first devices 100 as a single hardware device via its mass storage class driver to the notebook 51.

Although the USB standard has been described, it is envisaged that the present invention may use IEEE 1394 Firewire or other standards. Although USB Type A connectors have been described, it is possible to use USB Type B, USB Type Mini A and USB Type Mini B connectors.

Although flash memory has been described, it is envisaged that other types of memory may be used including solid state disks, hard disks or mini hard disks.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A portable data storage device for connection with an electronic device, the device comprising:
a first data connector for connecting to a host port of the electronic device,
a second data connector for connecting to a second portable data storage device,
wherein the first and second data connectors comply with a common connector standard.

2. The device according to claim 1, wherein the common connector standard is Universal Serial Bus (USB) or IEEE 1394.

3. The device according to claim 2, wherein the first data connector is a USB Type A male connector and the second data connector is a USB Type A female connector.

4. The device according to claim 1, further comprising a cascade module to copy a file allocation table of the second portable data storage device to a memory of the first portable data storage device when the second portable data storage device is operatively connected to the first portable data storage device.

5. The device according to claim 4, wherein the cascade module rearranges the file allocation table of the second portable data storage device.

6. The device according to claim 4, wherein the memory is volatile or non-volatile.

7. The device according to claim 4, the cascade module presents the first and second portable data storage devices as a single hardware device to the electronic device.

8. The device according to claim 7, the cascade module presents the first and second portable data storage devices in separate drives when the first and second portable data storage devices are operatively connected to the electronic device.

9. The device according to claim 7, wherein the cascade module presents the first and second portable data storage devices in a single drive, and the second portable data storage device is presented in a directory of the drive.

10. The device according to claim 7, wherein the file allocation tables of the first and second portable data storage devices are read when a read/write operation request to the first or second portable data storage devices is received, wherein the file allocation table of the second portable data storage device is read from the memory of the first portable data storage device.

11. The device according to claim 10, wherein the file allocation tables of the first and second portable data storage devices are each stored in non-volatile memory of the first and second portable data storage devices, respectively.

12. The device according to claim 1, further comprising an audio decoder to process and replay audio files selected from the group consisting of MP3, WAV and WMA files.

13. The device according to claim 1, further comprising a video decoder to process and replay video files selected from the group consisting of MPEG, AVI and ASF files.

14. The device according to claim 1, wherein the second data connector enables connection to a device without a file allocation table, the device being selected from the group consisting of printers, scanners, keyboards, mice, joysticks, flight yokes, digital cameras, webcams, scientific data acquisition devices, modems, or speakers.

15. The device according to claim 1, further comprising a third data connector for connecting with a third portable data storage device or non-storage device and create a hub, wherein the first, second and third data connectors comply with a common connector standard.

16. A method for cascading at least two portable data storage devices to connect with an electronic device, the method comprising:
operatively connecting a first portable data storage device to a host port of the electronic device;
operatively connecting a second portable data storage device to the first portable data storage device;
wherein a file allocation table of the second portable data storage device is copied to a memory of the first portable data storage device when the second portable data storage device is operatively connected to the first portable data storage device.

17. The method according to claim 16, further comprising operatively connecting additional portable data storage devices, wherein the file allocation table of each additional portable data storage device is ultimately copied to the memory of the first portable data storage device.

18. A portable data storage device for connection with an electronic device, the device comprising:
a first data connector for connecting to a host port of the electronic device;
memory for receiving and storing data from the electronic device via the host port; and
a second data connector for connecting to a second portable data storage device thereby to facilitate communication between the electronic device and the second portable data storage device via the first data connector;
wherein the first and second data connectors comply with a common connector standard.

19. The device according to claim 18, further comprising a cascade module to copy a file allocation table of the second portable data storage device to a memory of the first portable data storage device when the second portable data storage device is operatively connected to the first portable data storage device.

20. The device according to claim 18, wherein the common connector standard is Universal Serial Bus (USB) or IEEE 1394.
